(19) United States
(12) Patent Application Publication
(10) Pub. No.: US 2003/0058362 A1
(43) Pub. Date: Mar. 27, 2003

(54) Combined digital and conventional camera

(76) Inventor: Leo Weng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/960,991

(22) Filed: Sep. 25, 2001

(51) Int. Cl. H04N 5/225; H04N 7/18; H04N 9/07

(52) U.S. Cl. 348/340; 348/343; 348/337; 348/64

(57) ABSTRACT

A combined digital and conventional camera is provided. The camera comprises a spectrometer, a first lens, a first medium, a second lens, a second medium, and a control stopper. The spectrometer is a spectroscope or a prism. The first medium is a film of a conventional camera, and the second medium is a light bean sensitive element, such as a charge coupling element, an image vacuum tube, or a complimentary metal-oxide semiconductor of a digital camera. By the spectrometer, light bean can be projected to the first medium and second medium for imaging and recording. Therefore, the functions of a conventional camera and a digital camera can be used at the same time. Then, the control stopper controls the succeeding process. Thereby, the digital camera and conventional camera can be used alternatively.

### BACKGROUND OF THE INVENTION

1. Field of the Invention

The present invention relates to a combined digital and conventional camera structure, which provides a spectrometer so that light bean incident into the camera can be used by a conventional camera or a digital camera, thereby, the conventional camera and digital camera can be used alternatively.

2. Description of the Related Art

With the advance of digital technology, digital camera has become a popular product for capturing an image. The digital cameras have the advantages of easily carrying, no film and no developing process being required.

Referring to FIG. 1, a schematic view illustrated the basic principle of a camera is illustrated. As shown in the figure, the prior camera has a pinhole at a dark case. When light bean passes through the pinhole, the scenery of the outer side will cause an inverse image at one end of the case since reflected light bean travels straightly. The inverse image will form a latent image on a sensitive film.

The initial camera is designed by a light bean transmitting principle of a pinhole. Since light bean passing through the pinhole is very weak, the exposing time is very long, while the image is not clear. Afterwards, people discover that the focusing effect of a convex lens is better than the pinhole. Thus, convex lens is used to replace the pinhole. Furthermore, an aperture is added behind the convex lens. This is an initial type of the modern camera.

The digital camera is a combination of a conventional camera and a scanner. The principle of the digital camera is very similar to the conventional camera. In these two kinds of cameras, an optic lens is used to focus light bean reflected from an object to the interior of a camera. The difference of the two is that the medium is different. In the conventional camera, the light bean sensitive agent on the film is reacted by light bean so that image can be recorded on a film. In general, the film is a silver bromide plastic film. Thereby, the processes of developing, quick control, and setting are performed. The digital camera uses the image sensing functions of charge coupled device (CCD), or complimentary metal-oxide semiconductor (CMOS) so that light bean reflected from an object is converted into digital signals and then stored in a built-in RAM or a portable PC card. The image data can be read out for viewing.

The conventional photographs have 1.2 to 1.4M pixels or more pixels. Therefore, the photographs have a more beautiful quality. However, the conventional camera is not beneficial for real-time viewing an image or outputting an image. The photographs from a digital camera have less pixels of about 640×480 of 800×600. Therefore, the image can be outputted easily and viewed real-time, but the photographs are not so beautiful as those captured by a conventional camera. However, it is very inconvenient for a user to carry both a digital camera and a conventional camera so as to obtain the advantages of these two kinds of cameras .

### SUMMARY OF THE INVENTION

Accordingly, the primary object of the present invention is to provide a combined digital and conventional camera, wherein a spectrometer is provided for recording an image by a way of a conventional camera or a way of a digital camera. Thereby, features of a conventional camera and a digital camera may be presented as required.

The advantages of a digital camera is real-time imaging, capturing a large amount of images, no wasted material, easily storage and editing. The advantage of a conventional camera are convenient, has a lower fault rate, high resolution and high quality. The present invention provides a camera having the advantages of a digital camera and a conventional camera. The camera comprises a spectrometer, a first lens, a first medium, a second lens, a second medium, and a control stopper. The spectrometer is a spectroscope or a prism. The first medium is a film of a conventional camera, and the second medium is a light bean sensitive element, such as a charge coupling element, an image vacuum tube, or a complimentary metal-oxide semiconductor of a digital camera. By the spectrometer, light bean can be projected to the first medium and second medium for imaging and recording. When light bean incident into a camera through a spectrometer, the spectrometer will divide the light bean so that a part of the light bean from the spectrometer will form and record an image on the first medium with respect to the first lens. The other light bean from the spectrometer will form and record an image on a second medium with respect to the second lens.

The various objects and advantages of the present invention will be more readily understood from the following detailed description when read in conjunction with the appended drawing.

### BRIEF DESCRIPTION OF THE DRAWINGS

FIG. 1 is a schematic view showing the basic principle of a camera.

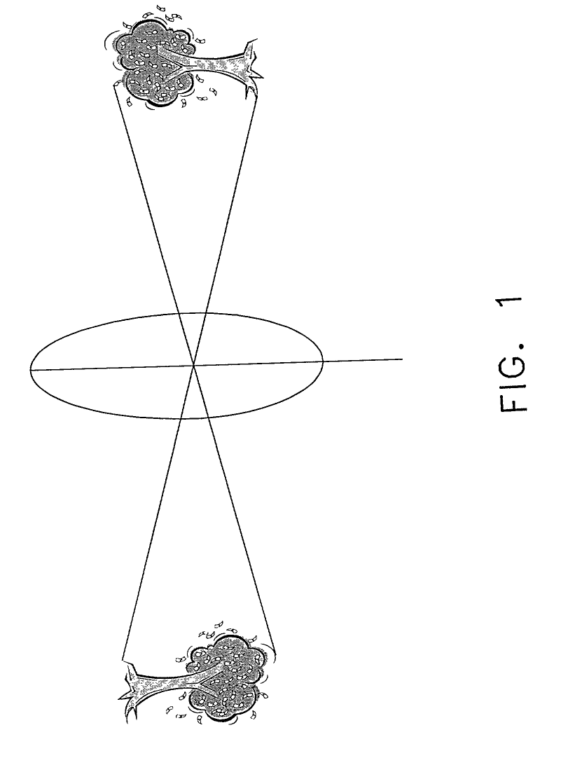

FIG. 2 is a schematic view showing the first embodiment of the present invention.

FIG. 3 is a schematic view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

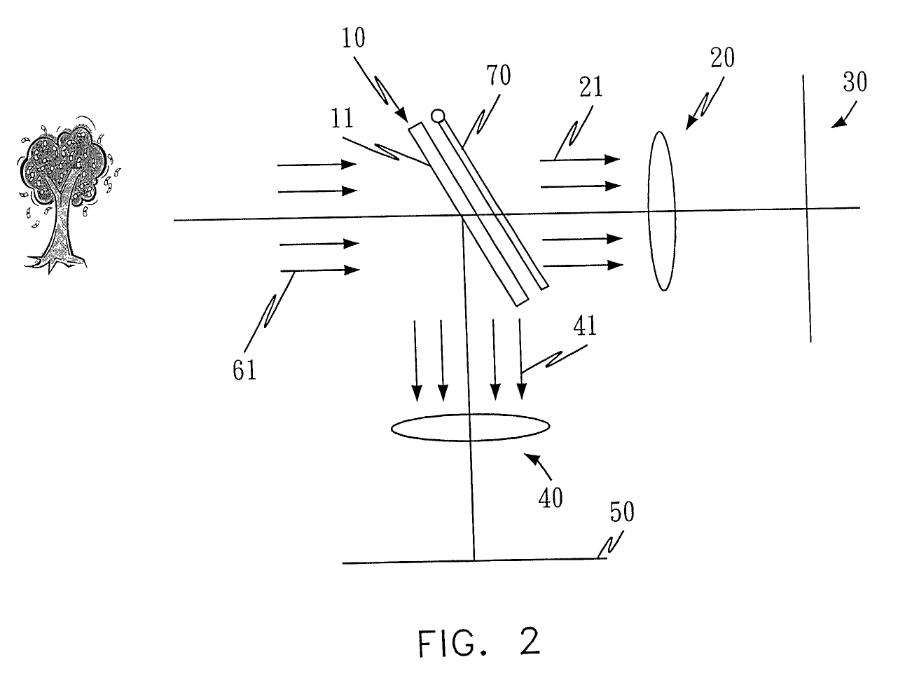

Referring to FIG. 2, a schematic view of the first embodiment of the camera structure of the present invention is illustrated. The camera structure of the present invention includes a spectrometer 10, a first lens 20, a first medium 30, a second lens 40, and a second medium 50. The spectrometer 10 includes a spectroscope (or light bean refraction lens) 11. When light bean 61 reflected by outer object incidents into the camera and passes through the spectroscope 11, the spectroscope 11 is utilized to divide the inlet light bean into a first light bean 21 and a second light bean 41. The first light bean 21 passes through the face tracking engine, and is imaged and recorded in the first medium 30, and the second light bean 42 passed through the second lens 40 and is imaged and recorded on the second medium 50.

The first lens 20 and the second lens 40 may be convex lens or compound lens set. The compound lens set is formed by a plurality of convex lens for enhancing the quality of an image. The first medium 30 is a light bean sensitive piece which is a plastic film of silver bromide. After sensitization, the particles will generate a chemical reaction. Then the image is processed through the processes of developing and fixing to be converted into an image capable of being viewed by human eyes. The second medium 50 may be one of a charge coupled device (CCD), complimentary metal-oxide semiconductor (CMOS). Then, light bean of an object is converted into digital signals. The signals are compressed and then is stored in an RAM or a portable PC card.

Moreover, the spectrometer 10 is installed with a control stopper 70 at a position with respect to the first lens 20. The control stopper 70 may control the first light bean 21 independently to project to the first lens 20. In other word, when the control stopper 70 is opened, the light bean 61 passing through the spectrometer 10 will cause the first light bean 21 to project to the first lens 20 and is imaged and recorded on the first medium 30. When the control stopper 70 is closed, after the light bean passes through the spectrometer 10, since the control stopper 70 shields the light bean bean, it can not project to the first lens 20 as the first light bean 21. That is, by the control stopper 70 to open or close a conventional camera. As for the operation of a digital camera, it is controlled by the switch (not shown) as in the prior art. Therefore, as the switch of the digital camera is actuated, and the control stopper 70 is closed, only the second light bean 41 projects to the second lens 40 to be used only by the digital camera. When the control stopper 70 is opened and the digital camera is closed (the switch of the digital camera does not be actuated), only the first light bean 21 transmits through the first lens 20 to be imaged on the first medium 30, that is, it is only used by the conventional camera. If the control stopper 70 is opened and the switch of the digital camera is actuated at the same time, then the first light bean 21 and the second light bean 41 may be imaged and recorded both on the first medium 30 and the second medium 50. Namely, it can be used both as a conventional camera and a digital camera.

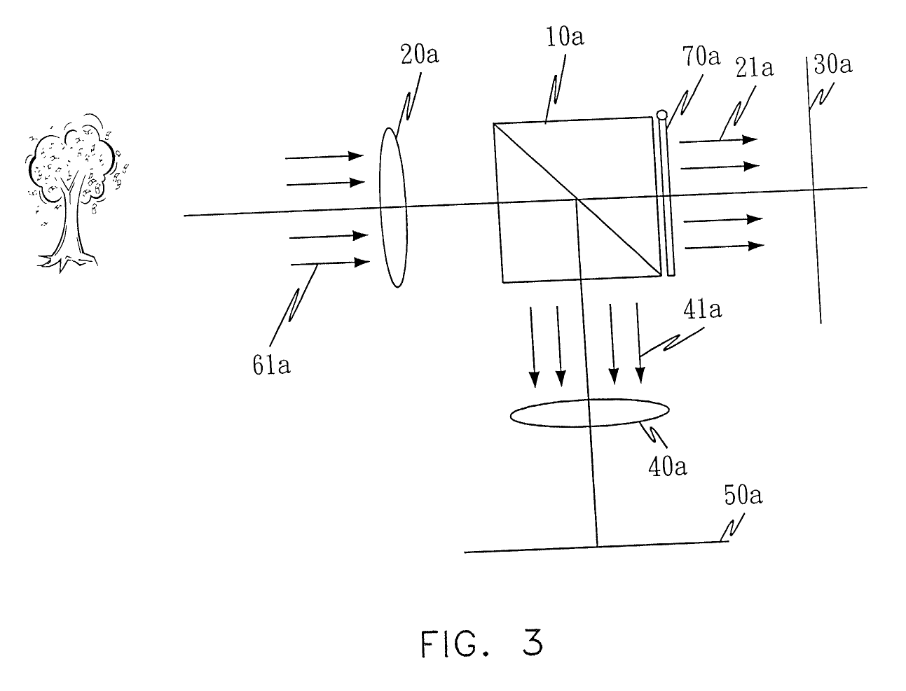

With reference to FIG. 3, a schematic view of the second embodiment of the present invention is illustrated. In this embodiment, the present invention includes a spectrometer 10a, a first lens 20a, a first medium 30a, a second lens 40a, and a second medium 50a. The spectrometer 10a includes a prism 11 a installed behind the first lens 20a. When the light bean 61a reflected by the outer object projects into the camera, it passes through the first lens 20a firstly and then passes through the prism 11a. The light bean incident into the prism 11a is divided into a first light bean 21a and a second light bean 41a. The first light bean 21a is imaged and recorded in the first medium 30a and the second light bean 41a is imaged and recorded on the second medium 50a. The spectrometer 10a has a control stopper 70a at position with respect to the first medium 30a. As described above, the control stopper 70a is used to control the imaging of the first light bean 21 on the first medium 30. That is, the control stopper 70 is utilized to control the opening and closing of a conventional camera.

In summary, the camera structure of the present invention will cause that the light bean entering into camera can be used by both a conventional camera and a digital camera. Therefore, the advantages of the conventional camera and the digital camera are included in the present invention. Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A camera comprising: a spectrometer dividing light bean incident to the camera into a first light bean in a direction straightly through said spectrometer and a second light bean perpendicular to said first light bean bean;
a first lens installed at a projecting portion of the first light bean;
a first medium installed at a succeeding portion of the first lens for receiving and recording the projected first light bean;
a second lens installed at a projecting portion of the second light bean; and
a second medium installed at a succeeding projecting portion of the second lens for receiving and recording the projecting second lens.

2. The camera as claimed in claim 1, wherein the first lens is selected from one of a convex lens and a compound lens set.

3. The camera as claimed in claim 1, wherein the second lens is selected from one of a convex lens and a compound lens set.

4. The camera as claimed in claim 2, wherein the compound lens set is formed by a plurality of convex lens.

5. The camera as claimed in claim 1, wherein the first medium is a light bean sensitive piece.

6. The camera as claimed in claim 5, wherein the light bean sensitive piece is a plastic film of silver bromide.

7. The camera as claimed in claim 1, wherein the second medium is selective from one of a group containing a charge coupling element, an image vacuum tube and a complimentary metal-oxide semiconductor.

8. The camera as claimed in claim 1, wherein the spectrometer is a spectroscope.

9. The camera as claimed in claim 1, wherein the spectrometer is installed with a control stopper for controlling the first light bean to project to the first lens.

10. A camera comprising:
a first lens receiving light bean incident into a camera;
a prism installed at a succeeding portion in a light bean path of the first lens, and dividing the light bean into a first light bean and a second light bean;
a first medium installed at a succeeding portion of the prism for receiving and recording the projected first light bean;
a second lens installed at a succeeding projecting portion of the second light bean; and
a second medium installed at a succeeding portion of the second lens for receiving and recording the projecting second lens.

11. The camera as claimed in claim 10, wherein the first lens is selected from one of a convex lens and a compound lens set.

12. The camera as claimed in claim 10, wherein the second lens is selected from one of a convex lens and a compound lens set.

13. The camera as claimed in claim 11, wherein the compound lens set is formed by a plurality of convex lens.

14. The camera as claimed in claim 10, wherein the first medium is a light bean sensitive piece.

15. The camera as claimed in claim 14, wherein the light bean sensitive piece is a plastic film of silver bromide.

16. The camera as claimed in claim 1, wherein the second medium is selective from one of a group containing a charge coupling element, image vacuum tube and complimentary metal-oxide semiconductor.

17. The camera as claimed in claim 1, wherein the prism has a control stopper at position with respect to the first medium for controlling the first light bean to project to the first medium.

18. A camera comprises a first lens, a second lens, a first medium, a second medium and a spectrometer, wherein the first medium is installed at a succeeding portion of a light bean path of the first lens for receiving and recording an incident light bean; the spectrometer is installed between the first lens and the second lens for dividing the light bean to be projected to the first medium and second medium.

19. The camera as claimed in claim 18, wherein the spectrometer includes a spectroscope for receiving light bean and then projecting the light bean to the first lens and the second lens.

20. The camera as claimed in claim 19, wherein the spectroscope is installed with a control stopper at a position with respect to the first lens.

21. The camera as claimed in claim 18, wherein the spectrometer is a prism; the prism is installed at a succeeding portion of a light bean path after the first lens receives light bean, and projects light bean to the first medium and second medium.

22. The camera as claimed in claim 21, wherein the prism is installed with a control stopper at position with respect to the first medium.

23. The camera as claimed in claim 18, wherein the first lens is selected from one of a convex lens and a compound lens set.

24. The camera as claimed in claim 18, wherein the second lens is selected from one of a convex lens and a compound lens set.

25. The camera as claimed in claim 23, wherein the compound lens set is formed by a plurality of convex lens.

26. The camera as claimed in claim 18, wherein the first medium is a light bean sensitive piece.

27. The camera as claimed in claim 26, wherein the light bean sensitive piece is a plastic film of silver bromide.

28. The camera as claimed in claim 18, wherein the second medium is selective from one of a group containing a charge coupling element, an image vacuum tube and a complimentary metal-oxide semiconductor.
